(19) United States
(12) Patent Application Publication
(10) Pub. No.: US 2024/0009743 A1
(43) Pub. Date: Jan. 11, 2024

(54) HOLE SAW AND METHOD OF MANUFACTURING A HOLE SAW

(71) Applicant: MILWAUKEE ELECTRIC TOOL CORPORATION, Brookfield, WI (US)

(72) Inventor: Rudolph Fortuna, Brookfield, WI (US)

(21) Appl. No.: 18/252,899

(22) PCT Filed: Nov. 18, 2021
(86) PCT No.: PCT/US2021/059828

§ 371 Date: May 15, 2023

Related U.S. Application Data
(60) Provisional application No. 63/115,706, filed on Nov. 19, 2020.

(51) Int. Cl. B23B 51/04

(52) U.S. Cl. CPC B23B 51/04

(57) ABSTRACT

A hole saw includes a cylindrical body, and end cap a plurality of cutting teeth, and an interlock. The cylindrical body is formed from a sheet including a first end, a second end opposite the first end, a cutting end, and a bottom end opposite the cutting end. The end cap is adjacent the bottom end of the cylindrical body. The plurality of cutting teeth is formed along the cutting end of the cylindrical body. The interlock extends between the cutting end and the bottom end. The interlock includes a first geometric pattern on the first end of the sheet and a second geometric pattern on the second end of the sheet that corresponds to the first geometric pattern.

### CROSS-REFERENCE TO RELATED APPLICATIONS

This claims the benefit of U.S. Provisional Patent Appl. No. 63/115,706, filed Nov. 19, 2020, the content of which is incorporated fully herein by reference.

### FIELD OF THE INVENTION

The present invention relates to power tool accessories, and more specifically to hole saws and hole saw manufacturing.

### BACKGROUND

A hole saw is a type of saw blade with a cylindrical, cup-like body that is rotated about a central axis in order to cut a cylindrical plug from a work piece, thereby forming a circular aperture in the work piece. Hole saws typically include a bottom opposite a cutting end that couples to a power tool. The bottom may be formed in a variety of ways.

### SUMMARY

In one aspect, the invention provides a hole saw including a cylindrical body formed from a sheet having a first end, a second end opposite the first end, a cutting end, and a bottom end opposite the cutting end. The hole saw also includes an end cap adjacent the bottom end of the cylindrical body, a plurality of cutting teeth formed along the cutting end, and an interlock extending between the cutting end and the bottom end. The interlock includes a first geometric pattern on the first end of the sheet and a second geometric pattern on the second end of the sheet that corresponds to the first geometric pattern.

In another aspect, the invention provides a method of manufacturing a hole saw. The method includes providing a sheet having a first end, a second end opposite the first end, a top end, and a bottom end opposite the top end. The method also includes forming a plurality of teeth along the top end between the first and second ends, forming a first geometric pattern along the first end of the sheet and a second geometric pattern along the second end of the sheet. The method further includes coupling the first geometric pattern with the second geometric pattern to form a cylindrical body. The method also includes providing an end cap adjacent the bottom end of the cylindrical body.

In another aspect, the invention provides a hole saw including a cylindrical body having a cutting end and a bottom end opposite the cutting end. The hole saw also includes an end cap adjacent the bottom end of the cylindrical body, and a plurality of cutting teeth formed along the cutting end. The cylindrical body and the end cap are integrally formed as a single piece.

In another aspect, the invention provides a method of manufacturing a hole saw. The method includes providing a sheet of material having a first end, a second end opposite the first end, a top end, a first portion, and a second portion. The method also includes forming a plurality of cutting teeth along the top end of the sheet, wrapping the sheet in a circle such that the first end is adjacent the second end and the first portion forms a cylindrical body, and folding the second portion inwardly relative to the first portion to form an end cap at a bottom end of the cylindrical body opposite from the top end.

In another aspect, the invention provides a hole saw including a cylindrical body having cutting end and a bottom end opposite the cutting end. The cylindrical body also has an inner surface. The hole saw also includes a plurality of cutting teeth formed along the cutting end, and an end cap coupled to the bottom end of the cylindrical body. The end cap includes a sidewall and a base. The sidewall extends into the cylindrical body and engages the inner surface. The base is offset radially inward from the inner surface and to form an annular lip between the cylindrical body and the end cap.

In another aspect, the invention provides a method of manufacturing a hole saw. The method includes providing a cylindrical body having a cutting end, a bottom end opposite the cutting end, and an inner surface. The method also includes providing an end cap having a sidewall and a base. The method further includes forming a plurality of teeth along the cutting end, and inserting the sidewall of the end cap into the cylindrical body such that the sidewall engages the inner surface and the base is offset radially inward from the inner surface to form an annular lip between the cylindrical body and the end cap.

Other aspects of the invention will become apparent by consideration of the detailed description and accompanying drawings.

### BRIEF DESCRIPTION OF THE DRAWINGS

FIG. 1 is a perspective view of a hole saw.

FIG. 2A is a perspective view of a hole saw according to another embodiment of the invention.

FIG. 2B is a plan view of a cylindrical body of the hole saw of FIG. 2A while in a flattened state.

FIG. 3 is a cross-sectional view of a hole saw according to another embodiment of the invention.

FIG. 4 is a cross-sectional view of a hole saw according to another embodiment of the invention.

FIG. 5 is a plan view of a portion of the hole saw of FIG. 4.

FIG. 6 is a side view of a portion of the hole of FIG. 4 according to another embodiment of the invention.

FIG. 7 is a cross-sectional view of a hole saw according to another embodiment of the invention.

FIG. 8 is a schematic of a portion of the hole saw of FIG. 7.

FIG. 9 is a cross-sectional view of a hole saw according to another embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

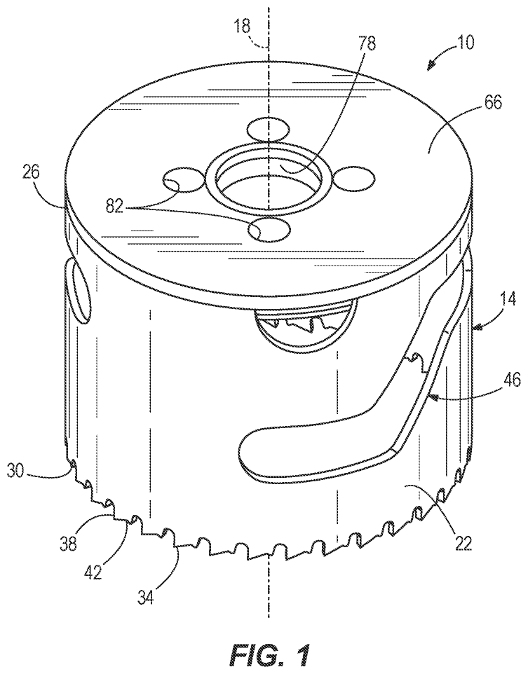

FIGS. 1-9 illustrate a power tool accessory, such as, for example, a hole-saw, for operation with a power tool (e.g., a drill, a driver-drill, a screwdriver, and the like). In some embodiments, the power tool accessory is operable to cut holes of different sizes in a work piece and/or to remove plugs from the work piece. Multiple methods and processes of manufacturing the power tool accessories for hole cutting are discussed below.

FIG. 1 illustrates an embodiment of a power tool accessory, and more specifically, a hole saw 10. The hole saw 10 includes a cylindrical body 14 disposed along an axis of rotation 18. The cylindrical body 14 is defined by a sidewall 22 that extends between an end cap 26 and a cutting end 30. As shown in FIG. 1, the cutting end 30 includes cutting teeth 34. Each of the teeth 34 is defined by a leading edge 38 and a trailing edge 42. The leading edge 38 may also be referred to as a rake face. The trailing edge 42 may also be referred to as a relief surface. In the illustrated embodiments, the end cap 26 includes a cap 66 that is coupled to the cylindrical body 14. In other embodiments, the cylindrical body 14 and the cap 66 may be integral with one another. The cap 66 defines a main aperture 78 centered about the axis 18 and configured to receive a mandrel or equivalent tool (not shown). A plurality of holes 82 are defined in the end cap 66 and surround the main aperture 78. The plurality of holes 82 are circumferentially arranged about the axis 18. In the illustrated embodiment, the hole saw 10 also includes a plurality of elongated apertures 46 to assist with plug removal.

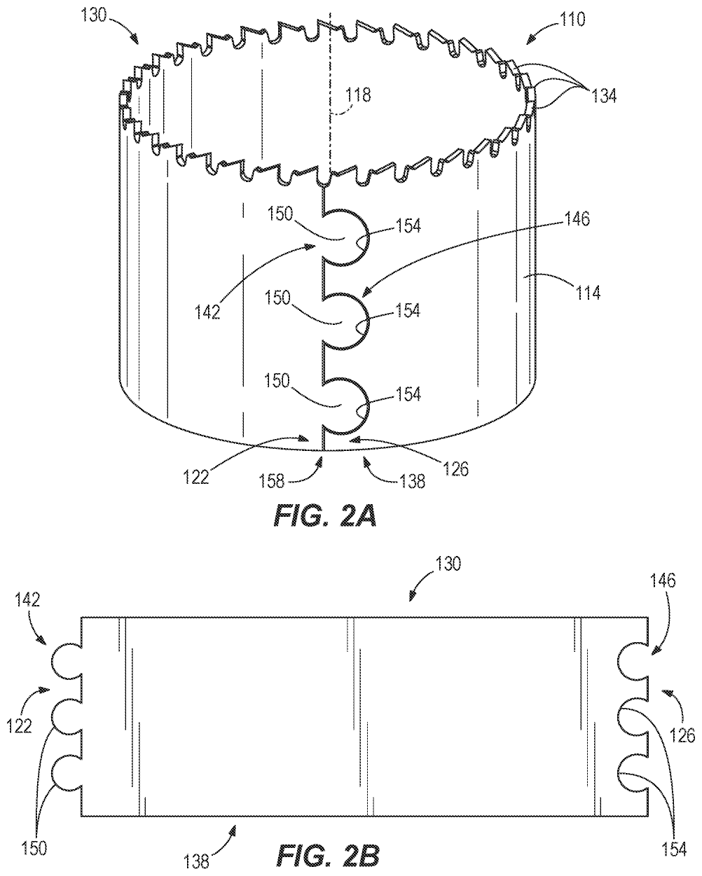

FIGS. 2A and 2B illustrate a hole saw 110 according to another embodiment of the invention. The hole saw 110 may be similar to the hole saw 110 described above. The hole saw 110 includes a cylindrical body 114 disposed about an axis of rotation 118. The cylindrical body 114 is formed from a sheet (FIG. 2B) including a first end 122, a second end 126 opposite the first end 122, a cutting end 130 with a plurality of cutting teeth 134, and an end cap 138 opposite the cutting end 130. The cylindrical body 114 can be a single piece with a first end 122 and a second end 126. In some embodiments, the cylindrical body 114 may be made up of multiple pieces manufactured together, each of the pieces having a first end and a second end.

Continuing to refer to FIGS. 2 and 2A, the first end 122 includes a first geometric pattern 142 and the second end 126 includes a second geometric pattern 146. In the illustrated embodiment, the first geometric pattern 142 corresponds to the second geometric pattern 146. In other words, the first geometric pattern 142 is inverse to the second geometric pattern 146 so that the first geometric pattern 142 fits within the second geometric pattern 146. In some embodiments, the first and second geometric patterns 142, 146 may extend the entire length of the first and second ends 122, 126, respectively, between the cutting end 130 and the end cap 138. In other embodiments, the first and second geometric patterns 142, 146 may extend only a portion of the first and second ends 122, 126 between the cutting end 130 and the end cap 138.

In the illustrated embodiment, the first geometric pattern 142 includes one or more tabs 150 that correspond to one or more indents 154 in the second geometric pattern 146. Each tab 150 corresponds to one indent 154, such that the tabs 150 and indents 154 are paired. The tabs 150 and the indents 154 may be tapered, circular, square, rectangular, or any other shape. Each of the pairs of tabs 150 and indents 154 may have the same shape or the pairs of tabs 150 and indents 154 can have different shapes.

During manufacturing of the hole saw 110, a sheet of material (e.g., metal—aluminum, steel, etc.) is provided. The sheet has the cutting end 130, the first end 122, and the second end 126. First, cutting teeth 134 are formed on the cutting end 130 of the sheet. A first geometric pattern 142 is formed on the first end 122 of the sheet, and a second geometric pattern 146 corresponding to the first geometric pattern 142 is formed on the second end 126 of the sheet. Then, the first geometric pattern 142 is pressed into the second geometric pattern 146 to define an interlock 158 between the first and second ends 122, 126 of the sheet to form a cylindrical body 114. As the geometric patterns 142, 146 are pressed together, the interlock 158 may pull the ends 122, 126 of the sheet into engagement to create a tight fit. The interlock 158 may be welded along the tabs 150 of the first geometric pattern 142 and indents 154 of the second geometric pattern 146. In other embodiments, the interlock 158 may be bonded in other ways, such as chemically. The interlock 158 formed by the first geometric pattern 142 and second geometric pattern 146 increases the area welded or bonded between the first end 122 and second end 126. Additionally, the interlock 158 may be materially stiffer than the rest of the cylindrical body 114 to create a desired grade of press fit for the interlock 158. The cylindrical body 114 may then be coupled to an end cap 138 by any method known in the art or by the methods discussed below.

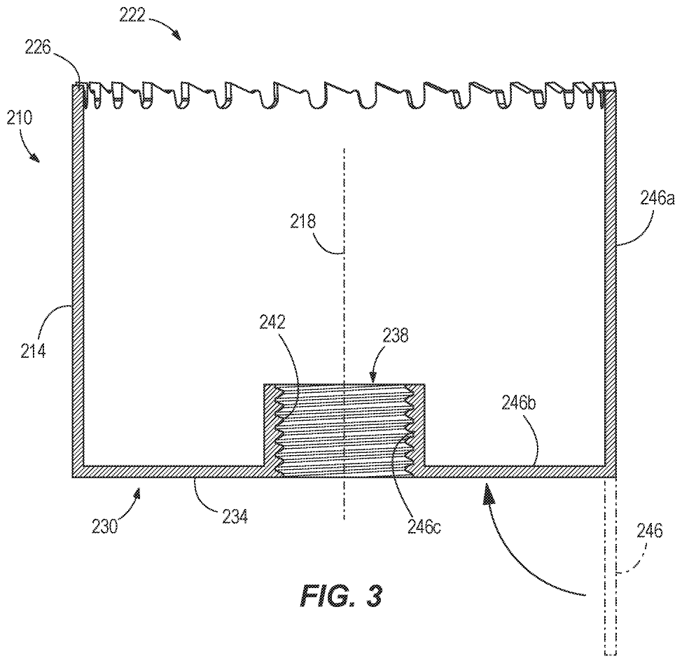

FIG. 3 illustrates a hole saw 210 according to another embodiment of the invention. The hole saw 210 includes a cylindrical body 214 disposed about an axis of rotation 218. The cylindrical body 214 includes a cutting end 222 with a plurality of cutting teeth 226 and an end cap 230. In the illustrated embodiment, the end cap 230 defines a base 234 that is integral with the cylindrical body 214. That is, the cylindrical body 214 and the end cap 230 are formed from a single piece of material. The base 234 defines a main aperture 238 with threads 242 that is configured to couple to a mandrel or arbor.

During manufacturing of the hole saw 210, a sheet of material is provided to create the cylindrical body 214 and the base 234. As shown in phantom lines, a portion 246b of the sheet is folded inwards toward the axis of rotation 218 to define the base 234 of the hole saw 210. In the illustrated embodiment, the portion 246 of the sheet is folded twice to define three distinct portions 246a, 246b, 246c of the hole saw 210. The first portion 246a defines the cylindrical body 214, the second portion 246b defines the base 234, and the third portion 246c defines the main aperture 238. The second portion 246b is folded perpendicular to the first portion 246a, and the third portion 246c is folded perpendicular to the second portion 246b. The cylindrical body 214 may be formed in a similar manner as discussed above by coupling a first end of the sheet to a second end of the sheet using the interlock. Other methods may also be used to form the cylindrical shape of the hole saw 210. The threads 242 may then be created in the third portion 246c of the sheet. In some embodiments, edges or fold lines between the portions 246a, 246b, 246c may include slots or cuts to remove material from the sheet such that the second and third portions 246b, 246c of the sheet do not fold or overlap when bent inward to form the base 234 and the main aperture 238.

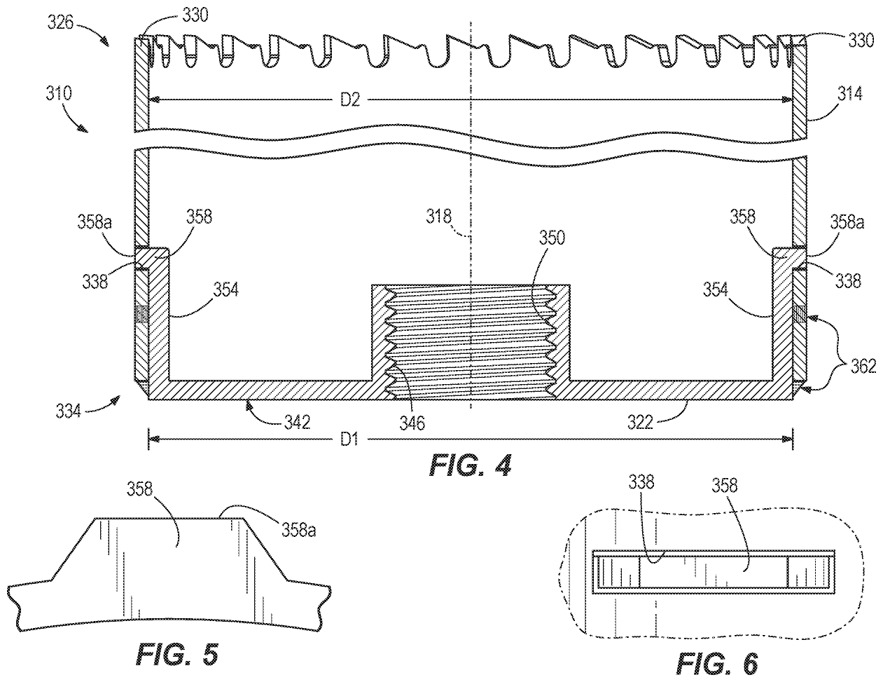

FIG. 4 illustrates a hole saw 310 according to another embodiment of the invention. The hole saw 310 includes a cylindrical body 314 formed about an axis of rotation 318 and a cylindrical end cap 322 mechanically coupled within an inner surface of the cylindrical body 314 by one or more tabs engaging one or more recesses, which define a fastener.

The cylindrical body 314 includes a cutting end 326 having a plurality of cutting teeth 330 and a bottom end 334 opposite the cutting end 326. Continuing to refer to FIG. 4, a plurality of recesses 338, or engaging surfaces, are defined in the cylindrical body 314 between the cutting end 326 and the bottom end 334. The recesses 338 are located at a height measured from the bottom end 334 of the cylindrical body 314. Each of the plurality of recesses 338 are shaped to engage a tab 358 (discussed below). In the illustrated embodiment, the plurality of recesses 338 are disposed circumferentially over a portion of the cylindrical body 314. In other words, in the illustrated embodiment, the plurality recesses 338 are positioned on a single horizontal plane extending through the axis of rotation 318. The plurality of recesses 338 can be disposed with equal spacing between adjacent recesses 338 about the circumference of the cylindrical body 314 or disposed with unequal spacing between adjacent recesses. In the illustrated embodiment, the recesses 338 extend completely through the cylindrical body 314. In other embodiments, the recesses 338 may only extend partially through the cylindrical body 314 from the inner surface. In an alternate embodiment, the cylindrical body 314 includes a single recess 338 configured to receive a single tab 358.

The end cap 322 includes a sidewall 354 and a base 342 that defines a threaded main aperture 346. The sidewall 354 has a cylindrical shape corresponding to and abutting the inner surface of the cylindrical body 314. In some embodiments, the threads 350 may be broach style threads. When coupled to the cylindrical body 314, the base 342 of the end cap 322 is offset from the bottom end 334 of the cylindrical body 314 to define an annular lip between the end cap 322 and the cylindrical body 314. In the illustrated embodiment, the base 342 of the end cap 322 is offset radially inward from the cylindrical body 314. That is, the base 342 has an outer diameter that is less than an outer diameter of the cylindrical body 314. The base 342 of the end cap 322 is also offset axially from the bottom end 334 of the cylindrical body 314. In the illustrated embodiment, the base 342 is axially offset past the bottom end 334 of the cylindrical body 314 such that the base 342 is positioned outside of the cylindrical body 314.

The end cap 322 further includes one or more tabs 358 (e.g., locating features) extending from a top end of the sidewall 354 and corresponding to the plurality of recesses 338. In the illustrated embodiment, the number of recesses 338 is the same as the number of tabs 358. The plurality of tabs 358 extend outward from the sidewall 354, relative to the axis of rotation 318, and are perpendicular to the sidewall 354. As shown in FIG. 4, a height of the tabs 358 is measured as the perpendicular distance from the base 342. Ends 358a of the tabs 358 have a geometry corresponding to a geometry of the recesses 338. The ends 358a extend into the recesses 338 of the cylindrical body 314 defining a mechanical fastener therebetween to couple the cylindrical body 314 to the end cap 322. In the illustrated embodiment, the height of the tabs 358 is greater than the height of the recesses 338 such that the annular lip is formed on an exterior surface, between cylindrical body 314 and the end cap 322. In other embodiments, the height of the tabs 358 is less than the height of the recesses 338, such that the annular lip is formed on an interior surface between the cylindrical body 314 and the end cap 322.

As shown in FIG. 5, the ends 358a of the tabs 358 may be tapered to create a press fit when inserted into a corresponding recess 338. Alternatively, as shown in FIG. 6, the ends 358a of the tabs 358 may be rectangular to create a tolerance fit when inserted into a corresponding recess 338. In other embodiments, the ends 358a of the tabs 358 may be other shapes such as circular, square, pointed, etc. In some embodiments, the ends 358a of the tabs 358 may be differently shaped to create a nominal fit or a slight inference fit with the recesses 338 of the cylindrical body 314. For example, the ends 358a of the tabs 358 may be triangular-shaped and the recesses 338 may also be triangular-shaped to receive and draw the cap 322 into the cylindrical body 314. In such an embodiment, the ends 358a of the tabs 358 may include surfaces that define a first angle that corresponds to surfaces of the recess 338 that define a second angle.

Further, in the illustrated embodiment, the ends 358a of the tabs 358 are flush with an outer surface of the cylindrical body 314. In other embodiments, the ends 358a of the tabs 358 may not be flush with the outer surface of the cylindrical body 314. For example, the ends 358a may protrude slightly from the outer surface of the cylindrical body 314.

As mentioned above, in the embodiment of FIG. 4, each of the tabs 358 protrudes from the top end of the sidewall 354. In other embodiments, the tabs 358 may protrude from the sidewall 354 midway between the top end of the sidewall and the bottom end 334 or at any position between the top end of the sidewall 354 and the bottom end 334. Likewise, each of the one or more tabs 358 may protrude from the sidewall 354 at a different position along the sidewall 354 between the top end and the bottom end. For example, one tab 358 may be positioned at the top end of the sidewall 354 and one tab 358 may be positioned at the bottom end of the sidewall 354. Alternatively, only one tab 358 may be positioned in the middle of the sidewall 354. In other embodiments, the tabs 358 may extend the full length of the sidewall 354 between the top end and the bottom end.

During manufacturing of the hole saw 310, the end cap 322 may be manufactured separately from the cylindrical body 314 and mechanically coupled to the cylindrical body 314. The end cap 322 may be folded in a similar manner as explained above to create the bottom 342, the sidewall 354, and the tabs 358. The portion forming the bottom 342 may be folded inward, toward the axis of rotation 318, such that the sidewall 354 and bottom 342 form a substantially right angle. The portion forming the main aperture 346, likewise, can be folded upward, parallel to the axis of rotation 318, such that the bottom 342 and main aperture 346 form a substantially right angle. The portion forming the tabs 358 may be folded outward, away from the axis of rotation 318, such that the tabs 358 and sidewall 354 form a right angle. The cylindrical body 314 can be fitted around the cap by aligning the tabs 358 with the recesses 338 of the cylindrical body 314, such that the plurality of tabs 358 engage the plurality of recesses 338. In other embodiments, the cylindrical body 314 can be formed and placed over the cap 322. In some embodiments, the cylindrical body may be formed with the interlock described above.

In other embodiments, the end cap 322 and the tabs 358 may be manufactured separately and welded together. For example, the end cap 322 may be folded to create the bottom 342 and the sidewall 354. The tabs 358 may then be fixed to a separate structure in a position that assists the tabs 358 with staying concentric with the cylindrical body 314. Next, the end cap 322 may be positioned with the tabs 358 about the end cap 322 and welded together. Such a manufacturing process would inhibit misalignment between the cap 322 and the cylindrical body 314 if the dimensions or the placement of the cap 322 were off due to manufacturing processes. The cylindrical body 314 may then be formed around the end cap 322 by aligning the tabs 358 with the recesses 338 of the cylindrical body 314. The tabs 358 may then be pushed or pulled through the recesses 338 with a tool. Such a manufacturing process would inhibit misalignment between the cap 322 and the cylindrical body 314 if the dimensions or the placement of the cap 322 were off due to manufacturing processes.

In a different embodiment, the end cap 322 and the cylindrical body 314 can also be coupled by a press fit. In this embodiment, the sidewall 354 of the end cap 322 may be sized so that a diameter D1 measured between opposing points of an outer surface of the sidewall 354 and through the axis of rotation 318 is greater than a diameter D2 of the cylindrical body 314 measured between opposing points of the inner surface and through the axis of rotation 318. In such an embodiment, the cap 322 may be coupled to the cylindrical body 314 by sliding the cylindrical body 314 over the tabs 358 to create a compression force on the outer surface of the sidewall 354 by the inner surface of the cylindrical body 314. When the tabs 358 reach the recesses 338, the compression force biases the tabs 358 into the recesses 338, forming a press fit between the cylindrical body 314 and the end cap 322. In some embodiments, additional welds may be applied between the end cap 322 and the cylindrical body 314 to further secure the cylindrical body 314 to the end cap 322. For example, the ends 358a of the tabs 358 and the recesses 338 may be welded together after the press fit is formed. As illustrated in FIG. 4, other weld spots 362 may also be positioned between the bottom end 334 of the cylindrical body 314 and the sidewall 354 of the end cap 322. In the illustrated embodiment, the tabs 358 and the recesses 338 may be seam welded or ear welded together.

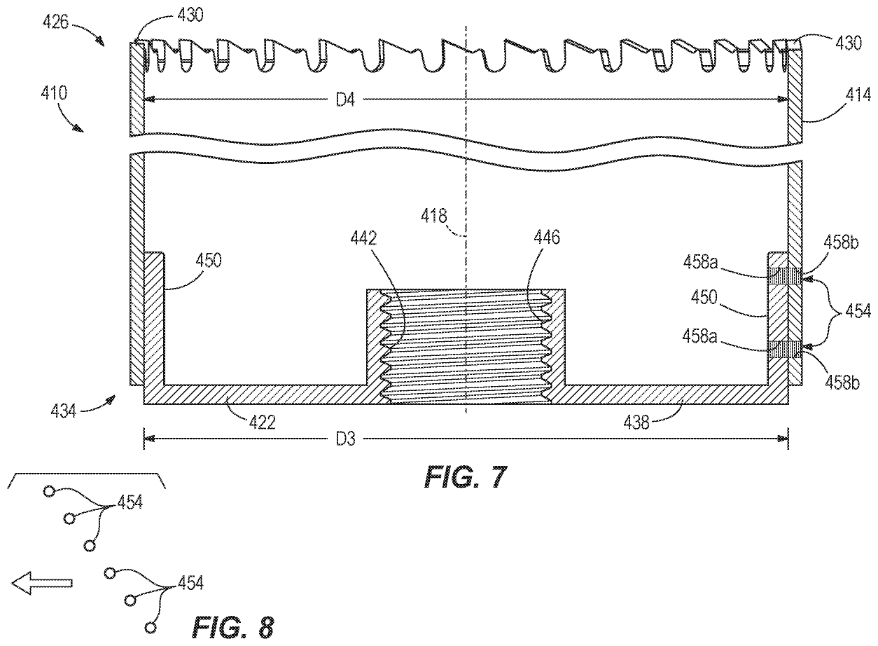

FIG. 7 illustrates a hole saw 410 according to another embodiment of the invention. The hole saw 410 is similar to the hole saw 310 and includes a cylindrical body 414 with an inner surface that fits over an outer surface of an end cap 422, forming an annular lip between the cylindrical body 414 and the cap 422. The hole saw 410, however, employs welds, rather than tabs 358 to secure the cylindrical body 414 and the cap 422. The cylindrical body 414 is formed about an axis of rotation 418 and the end cap 422. The cylindrical body 414 also includes a cutting end 426 with a plurality of cutting teeth 430. The end cap 422 includes a base 438 that defines a main aperture 442 with threads 446 and a sidewall 450.

As shown in FIG. 7, the end cap 422 has a diameter D3 measured through the axis of rotation 418. The cylindrical body 414 has a diameter D4 measured between opposing points on the inner surface of the through the axis of rotation 418. Similar to hole saw 310 described above, the diameter D3 of the end cap 422 is slightly greater than the diameter D4 of the cylindrical body 414. As such, the cylindrical body 414 may be coupled, or fitted, to the cap 422 with a press fit by sliding the inner surface of the cylindrical body 414 over the outer surface of the end cap 422. The slightly smaller D4 diameter of the cylindrical body 414 creates a compression force on the sidewall 450 of the end cap 422. The compression force biases the sidewalls 450 towards the inside of the cylindrical body 414 to inhibit movement of the cylindrical body 414 relative to the end cap 422. In other embodiments, the sidewalls 450 may be tapered or cone shaped to create the press fit with the inner surface of the cylindrical body 414.

Continuing to refer to FIG. 7, the hole saw 410 may also include a plurality of weld spots 454 defining a weld bond between the cylindrical body 414 and the end cap 422 to further secure or fit the end cap 422 to the cylindrical body 414. For example, weld holes 458a, 458b may be formed in the sidewall 450 of the end cap 422 and/or the cylindrical body 414. The weld bond is formed within the weld holes 458a, 458b. The weld holes 458a through the sidewall 450 are located at a height measured perpendicularly from the base 438 of the cap 422, and the weld hole 458b through the cylindrical body 414 are located at a height measured perpendicularly from a bottom end 434 of the cylindrical body 414. In the illustrated embodiment, the height of the weld holes 458a through the sidewall 450 is greater than the height of the weld holes 458b through the cylindrical body 414. The offset in weld hole height defines the annular lip between the cylindrical body 414 and the end cap 422. In some embodiments, the weld spots 454 may be arranged in a geometric pattern, as shown in FIG. 8, between an inside surface of the cylindrical body 414 and an outside surface of the cap 422. The geometric pattern can include angled weld spot patterns, as shown in FIG. 8. In other embodiments, the weld spots 454 can be arranged in vertical patterns, circular patterns, or in any other suitable pattern. In some embodiments, the plurality of weld spots 454 on hole saw 410 may include multiple weld spot patterns. For example, the geometric patterns may be a combination of vertical and angled weld spots 454. In some embodiments, the weld spots 454 can overlap to form a continuous weld line. The cylindrical body 414 and the end cap 422 can be joined at the weld spots 454 and through the weld holes 458a, 458b by any suitable welding technique. For example, the weld spots 454 may be stitch welded or button welded.

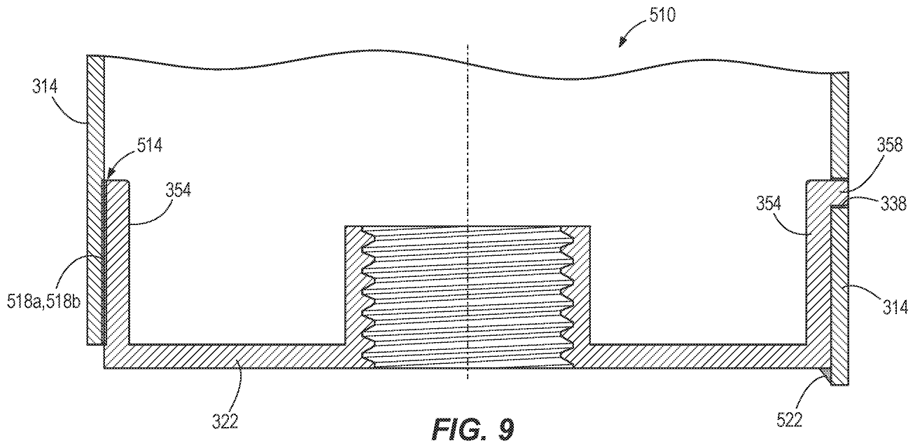

FIG. 9 illustrates a hole saw 510 according to another embodiment of the invention. The hole saw 510 is similar to the hole saw 310 discussed above with similar features being represented by similar reference numbers. As such, only those features that differ will be discussed below. The hole saw 510 includes the cylindrical body 314 and an end cap 322 coupled by a bonded fit 514 between the outer surface of the sidewall 354 and the inner surface of the cylindrical body 314. The bonded fit 514 may include a soft or hard coil 518a, 518b disposed between the outer surface of the sidewall 354 and the inner surface of the cylindrical body 314. The soft coil 518a may include a bond between the sidewall 354 and the cylindrical body 314 that is unaffected by temperature, or non-curing. Alternatively, the soft coil 518a may be temperature activated, or cured, to produce a stronger bonded fit between the cylindrical body 314 and the sidewall 354. The soft coil 518a may also include chemicals, ultraviolet light, water, or pressure as alternative activation methods to create the bonded fit 514 between the cylindrical body 314 and the sidewall 354. Likewise, the hard coil 518b may be chemically activated, brazed, or include ultraviolet light as activation methods to create the bonded fit 514 between the cylindrical body 314 and the sidewall 354. The hole saw 510 may additionally include mechanical fasteners and welds to join the cylindrical body 314 and the sidewall 354. As illustrated in FIG. 9, the hole saw 510 can have an inside weld 522 between an outer surface of the sidewall 354 and the cylindrical body 314

Although the invention has been described in detail with reference to certain preferred embodiments, variations and modifications exist within the scope and spirit of one or more independent aspects of the invention as described. Additionally, multiple methods discussed above may be combined to produce additional hole saw manufacturing methods.

1. A hole saw comprising:
a cylindrical body formed from a sheet including a first end, a second opposite the first end, a cutting end, and a bottom end opposite the cutting end;
an end cap adjacent the bottom end of the cylindrical body;
a plurality of cutting teeth formed along the cutting end; and
an interlock extending between the cutting end and the bottom end, the interlock including a first geometric pattern on the first end of the sheet and a second geometric pattern on the second end of the sheet that corresponds to the first geometric pattern.

2. The hole saw of claim 1, wherein the first geometric pattern includes a plurality of tabs and the second geometric pattern includes a plurality of indents.

3. The hole saw of claim 1, wherein the first geometric pattern extends an entire length of the first end of the sheet, and wherein the second geometric pattern extends an entire length of the second end of the sheet.

4. The hole saw of claim 1, wherein the end cap and the cylindrical body are integrally formed as a single piece.

5. The hole saw of claim 1, wherein the end cap includes a cylindrical sidewall having an outer surface abutting an inner surface of the cylindrical body.

6. The hole saw of claim 5, further comprising a mechanical fastener between the cylindrical sidewall and the inner surface of the cylindrical body.

7. The hole saw of claim 5, further comprising a weld bond between the cylindrical sidewall and the inner surface of the cylindrical body.

8. The hole saw of claim 5, further comprising a press fit between the cylindrical sidewall and the inner surface of the cylindrical body.

9. A method of manufacturing a hole saw, the method comprising:
providing a sheet including a first end, a second end opposite the first end, a top end, and a bottom end opposite the top end;
forming a plurality of cutting teeth along the top end between the first and second ends;
forming a first geometric pattern along the first end of the sheet and a second geometric pattern along the second end of the sheet that corresponds with the first geometric pattern;
coupling the first geometric pattern with the second geometric pattern to form a cylindrical body; and
providing an end cap adjacent the bottom end of the cylindrical body.

10. The method of claim 9, wherein coupling the first geometric pattern with the second geometric pattern includes pressing the first geometric pattern into the second geometric pattern to define an interlock therebetween.

11. The method of claim 9, wherein coupling the first geometric pattern with the second geometric pattern includes welding the first geometric pattern and the second geometric pattern.

12. The method of claim 9, wherein forming the first geometric pattern includes forming a plurality of tabs along the first end of the sheet, and wherein forming the second geometric pattern includes forming a plurality of indents along the second end of the sheet.

13. The method of claim 9, wherein providing the end cap includes integrally forming the end cap as a single piece with the cylindrical body.

14. The method of claim 9, wherein providing the end cap includes mechanically coupling the end cap to the cylindrical body.

15-34. (canceled)
